(19) United States
(12) Patent Application Publication
(10) Pub. No.: US 2010/0104996 A1
(43) Pub. Date: Apr. 29, 2010

(54) BAKING APPARATUS

(75) Inventor: Tokuo Yoshida, Osaka-shi (JP)

Correspondence Address: SHARP KABUSHIKI KAISHA;C/O KEATING & BENNETT, LLP, 1800 Alexander Bell Drive, SUITE 200, Reston, VA, 20191, US

(73) Assignee: SHARP KABUSHIKI KAISHA, Osaka-shi, Osaka (JP)

(21) Appl. No.: 12/530,490

(22) PCT Filed: Feb. 15, 2008
(86) PCT No.: PCT/JP2008/000235

§ 371 Date: Sep. 9, 2009

(30) Foreign Application Priority Data
Jun. 25, 2007 (JP) 2007-166182

(51) Int. Cl. F27D 3/00

(52) U.S. Cl. 432/121

(57) ABSTRACT

A baking apparatus includes a baking chamber and a plurality of guide rolls provided inside the baking chamber so that their respective rotation shafts extend parallel or substantially parallel to each other. The baking apparatus bakes a thin film on a film substrate contained in the baking chamber, while sequentially passing the film substrate to the plurality of guide rolls. The plurality of guide rolls are arranged in a spiral manner in the order that the film substrate is passed.

### BACKGROUND OF THE INVENTION

1. Field of the Invention

The present invention generally relates to baking apparatuses. More particularly, the present invention relates to roll-to-roll baking apparatuses.

2. Description of the Related Art

In recent years, flexible display panels using flexible film substrates instead of conventionally used glass substrates have been developed in liquid crystal displays, organic EL (electro luminescence) displays, and the like. A roll-to-roll method capable of continuously processing a film substrate is preferable, in terms of productivity, for manufacturing of such display panels using film substrates.

For example, Japanese Published Patent Application No. S60-239232 discloses a method for manufacturing a composite material, in which polytetrafluoroethylene, which covers a heat-resistant fiber material, or with which a heat-resistant fiber material is impregnated, is baked by a roll-to-roll method.

Incidentally, manufacturing of liquid crystal display panels requires, for example, baking of alignment films printed on the respective surfaces of a TFT (thin film transistor) substrate and a counter substrate.

FIGS. 10 and 11 are side views showing the internal structures of conventional alignment-film baking apparatus 140a and 140b, respectively.

Baking an alignment film requires, for example, heating at 200° C. for about one hour. Thus, as shown in FIG. 10, in the case of baking an alignment film 106 on a film substrate 105 while transferring the film substrate 105 so as not to bend the film substrate 105 inside the alignment-film baking apparatus 140a, the area occupied by the apparatus on the floor surface, that is, the so-called “footprint,” becomes very large.

Thus, as shown in FIG. 11, it is possible to arrange a plurality of guide rolls 111 through 119 alternately in upper and lower positions inside the alignment-film baking apparatus 140b, and to bake an alignment film 106 on a film substrate 105 by sequentially passing the film substrate 105 to the guide rolls 111 through 119. However, since reducing the footprint requires reduction in diameter of the guide rolls 111 through 119, the film substrate 105 may suffer from a stress whitening and damage if bent by the peripheral walls of the guide rolls 111 through 119.

### SUMMARY OF THE INVENTION

In view of the above problems, preferred embodiments of the present invention provide an apparatus for baking a thin film on a film substrate, while reducing the footprint and damage to the substrate as much as possible.

According to a preferred embodiment of the present invention, a plurality of guide rolls, to which a film substrate is sequentially passed, are arranged in a spiral pattern in the order that the film substrate is passed over the plurality of guide rolls.

More specifically, a baking apparatus according to a preferred embodiment of the present invention includes: a baking chamber; and a plurality of guide rolls provided inside the baking chamber so that their respective rotation shafts extend parallel or substantially parallel to each other. The baking apparatus bakes a thin film on a film substrate contained in the baking chamber, while sequentially passing the film substrate to the plurality of guide rolls. The plurality of guide rolls are arranged in a spiral manner in the order that the film substrate is passed over the guide rolls.

According to the above structure, even if the respective diameters of the guide rolls are increased in order to prevent damage to the film substrate, the guide rolls, to which the film substrate is sequentially passed, are arranged in a spiral pattern in the baking chamber in the order that the film substrate is passed, and thus, the footprint of the baking chamber can be reduced as compared to, for example, the case where a plurality of guide rolls are arranged alternately in the upper and lower positions. Thus, the thin film on the film substrate can be baked, while reducing the footprint, and damage to the substrate as much as possible.

The respective rotation shafts of the guide rolls may extend in a direction parallel or substantially parallel to a floor surface.

According to the above structure, the film substrate is transferred along the guide rolls so that the film substrate is held horizontally in its width direction. Thus, even if the temperature in the baking chamber varies along the height direction of the baking chamber, the film substrate is heated uniformly in the width direction.

The respective rotation shafts of the guide rolls may extend in a direction perpendicular or substantially perpendicular to a floor surface.

According to the above structure, the film substrate is transferred along the guide rolls so that the film substrate is held vertically in its width direction. Thus, if the temperature in the baking chamber varies along the height direction of the baking chamber, the film substrate can be heated under different conditions on both sides of the film substrate along its width direction.

A wind-up roll for winding up the film substrate which has been passed to the plurality of guide rolls, or a wind-off roll for winding off the film substrate which is to be passed to the plurality of guide rolls, may be provided in a central portion of the baking chamber.

According to the above structure, the thin film on the film substrate is baked, while the film substrate, which has been passed to the plurality of guide rolls, is wound up onto the wind-up roll in the baking chamber, or while the film substrate, which has been wound off from the wind-off roll, is passed to the plurality of guide rolls in the baking chamber. Thus, the functions and effects of preferred embodiments of the present invention are specifically implemented.

The baking apparatus may further include a transferring apparatus for transferring the wind-up roll or the wind-off roll.

According to the above structure, the film substrate in a roll form, which has been passed to the plurality of guide rolls, is carried out of the baking chamber, or the film substrate in a roll form, which is to be passed to the plurality of guide rolls, is carried into the baking chamber, by the transferring apparatus.

A rotation shaft of the wind-up roll or the wind-off roll may extend parallel or substantially parallel to a floor surface, and the transferring apparatus may be configured to support the rotation shaft of the wind-up roll or the wind-off roll.

According to the above structure, for example, the transferring apparatus includes an insertion portion arranged to be inserted into the rotation shaft (a hollow core) of the wind-up roll or the wind-off roll to support the rotation shaft of the wind-up roll or the wind-off roll. Thus, the film substrate in a roll form, which has been passed to the plurality of guide rolls, is specifically carried out of the baking chamber, or the film substrate in a roll form, which is to be passed to the plurality of guide rolls, is specifically carried into the baking chamber, by the transferring apparatus.

A rotation shaft of the wind-up roll or the wind-off roll may extend perpendicularly or substantially perpendicularly to a floor surface, and the transferring apparatus may be configured to latch an upper portion of the wind-up roll or the wind-off roll.

According to the above structure, for example, a latch portion is provided in the upper portion of the wind-up roll or the wind-off roll, and the transferring apparatus includes an engaging portion for engaging and holding the latch portion. Thus, the film substrate in a roll form, which has been passed to the plurality of guide rolls, is specifically carried out of the baking chamber, or the film substrate in a roll form, which is to be passed to the plurality of guide rolls, is specifically carried into the baking chamber, by the transferring apparatus.

A wind-off roll for winding off the film substrate which is to be passed to the plurality of guide rolls may be provided in a central portion of the baking chamber, and a cooling chamber for cooling the film substrate, which has been passed to the plurality of guide rolls after being wound off from the wind-off roll, may be provided outside the baking chamber.

According to the above structure, the film substrate, which has been heated by passing the film substrate, wound off from the wind-off roll, to the plurality of guide rolls in the baking chamber, is cooled in the cooling chamber.

A cooling plate for cooling the film substrate by contacting the film substrate may be provided in the cooling chamber.

According to the above structure, the film substrate, which has been heated by passing the film substrate, wound off from the wind-off roll, to the plurality of guide rolls in the baking chamber, is specifically cooled by the cooling plate provided in the cooling chamber.

A jet nozzle for blowing air to the film substrate to cool the film substrate may be provided in the cooling chamber.

According to the above structure, the film substrate, which has been heated by passing the film substrate, wound off from the wind-off roll, to the plurality of guide rolls in the baking chamber, is specifically cooled by the air blown from the jet nozzle provided in the cooling chamber.

According to various preferred embodiments of the present invention, a plurality of guide rolls, to which a film substrate is sequentially passed, are arranged in a spiral pattern in the order that the film substrate is passed over the guide rolls. Thus, a thin film on the film substrate can be baked, while reducing the footprint and damage to the substrate as much as possible.

Other features, elements, steps, characteristics and advantages of the present invention will become more apparent from the following detailed description of preferred embodiments of the present invention with reference to the attached drawings.

### BRIEF DESCRIPTION OF THE DRAWINGS

FIG. 1 is a side view showing the internal structure of a baking apparatus 50a according to a first preferred embodiment.

FIG. 2 is a front view of a transferring apparatus 30a of the baking apparatus 50a.

FIG. 3 is a side view of the transferring apparatus 30a of the baking apparatus 50a.

FIG. 4 is a top view showing the internal structure of a baking apparatus 50b according to a second preferred embodiment.

FIG. 5 is a side view of a transferring apparatus 30b of the baking apparatus 50b.

FIG. 6 is a side view of a transferring apparatus 30c of the baking apparatus 50b.

FIG. 7 is a side view showing the internal structure of a baking apparatus 50c according to a third preferred embodiment.

FIG. 8 is a side view showing the internal structure of a baking apparatus 50d according to a fourth preferred embodiment.

FIG. 9 is a top view showing the internal structure of a baking apparatus 50e according to a fifth preferred embodiment.

FIG. 10 is a side view showing the internal structure of a conventional alignment-film baking apparatus 140a.

FIG. 11 is a side view showing the internal structure of a conventional alignment-film baking apparatus 140b.

### DETAILED DESCRIPTION OF THE PREFERRED EMBODIMENT

Preferred embodiments of the present invention will be described in detail below with reference to the accompanying drawings. Note that, although a baking apparatus for baking an alignment film on a film substrate is shown by way of example in the following preferred embodiments, the present invention is not limited to the following preferred embodiments.

### First Preferred Embodiment

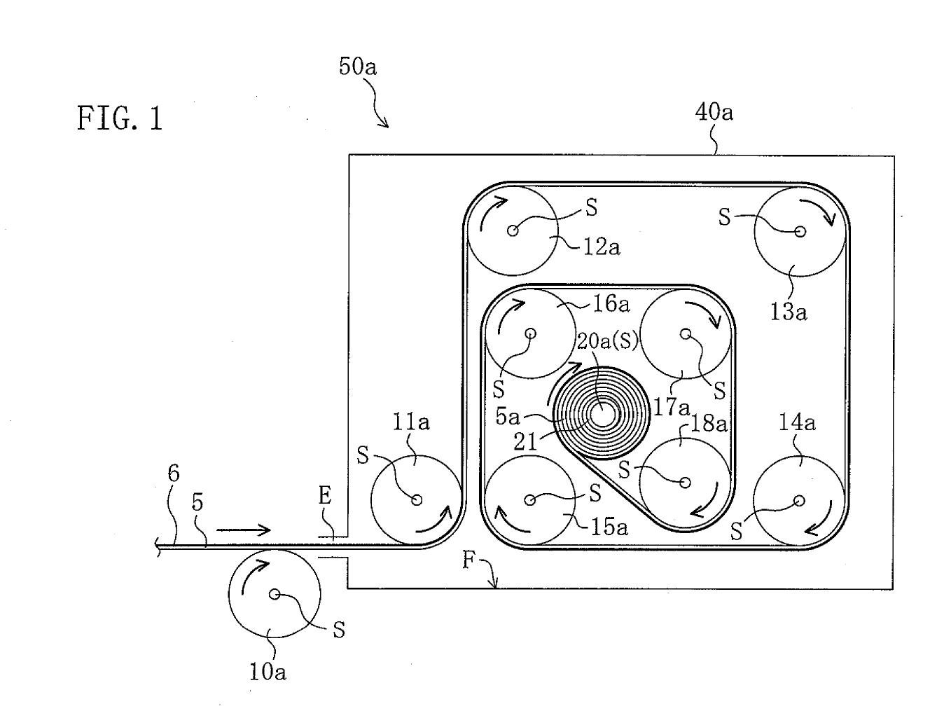

FIGS. 1 through 3 show a first preferred embodiment of a baking apparatus according to the present invention. FIG. 1 is a side view specifically showing the internal structure of a baking apparatus 50a of the present preferred embodiment.

As shown in FIG. 1, the baking apparatus 50a includes, for example, a feed roll 10a for feeding a film substrate 5, having an alignment film 6 printed thereon by an alignment-film printing apparatus (not shown) in the previous step, to the next step, and a baking chamber 40a for baking the alignment film 6 on the film substrate 5 which has been carried into the baking chamber 40a through a carry-in port E after being fed by the feed roll 10a.

As shown in FIG. 1, the baking chamber 40a includes the following components inside: a first guide roll 11a provided near the carry-in port E in the lower left portion in the figure, for guiding the film substrate 5 from the feed roll 10a in the upward direction in the figure; a second guide roll 12a provided in the upper left portion in the figure, for guiding the film substrate 5 from the first guide roll 11a in the right direction in the figure; a third guide roll 13a provided in the upper right portion in the figure, for guiding the film substrate 5 from the second guide roll 12a in the downward direction in the figure; a fourth guide roll 14a provided in the lower right portion in the figure, for guiding the film substrate 5 from the third guide roll 13a in the left direction in the figure; a fifth guide roll 15a provided on the right side of the first guide roll 11a in the figure, for guiding the film substrate 5 from the fourth guide roll 14a in the upward direction in the figure; a sixth guide roll 16a provided above the fifth guide roll 15a and below the second guide roll 12a in the figure, for guiding the film substrate 5 from the fifth guide roll 15a in the right direction in the figure; a seventh guide roll 17a provided on the right side of the sixth guide roll 16a and on the lower left side of the third guide roll 13a in the figure, for guiding the film substrate 5 from the sixth guide roll 16a in the downward direction in the figure; an eighth guide roll 18a provided below the seventh guide roll 17a and on the left side of the fourth guide roll 14a in the figure, for guiding the film substrate 5 from the seventh guide roll 17a in the upper left direction in the figure; a wind-up roll 20a provided at an intermediate position of the fifth guide roll 15a, the sixth guide roll 16a, the seventh guide roll 17a, and the eighth guide roll 15a, for winding up the film substrate 5 from the eight guide roll 18a; and a heater (not shown) for heating the inside of the chamber.

Respective rotation shafts S of the feed roll 10a, the guide rolls 11a through 18a, and the wind-up roll 20a preferably extend in a direction parallel or substantially parallel to a floor surface F of the baking chamber 40a, that is, in the horizontal direction.

The guide rolls 11a through 18a are preferably made of aluminum or other suitable material, and preferably have a columnar shape with, for example, a width of about 550 mm and a diameter of about 200 mm.

A core 21 attached to the wind-up roll 20a is preferably made of aluminum or other suitable materials, and preferably has a cylindrical shape with, for example, a width of about 550 mm and a diameter of about 80 mm.

For example, the respective diameters of the guide rolls 11a through 18a and the core 21 are preferably about 75 mm or more in order to reduce damage to the film substrate 5 which is transferred on their peripheral walls, and are preferably about 300 mm or less in order to reduce the footprint.

The heater preferably is an infrared heater, a hot air circulating heater, or the like.

As shown in FIG. 1, the baking apparatus 50a is configured to bake the alignment film 6 on the film substrate 5, while sequentially passing the film substrate 5, which has been carried into the baking chamber 40a through the carry-in port E, to the guide rolls 11a through 18a, and then, to wind up the film substrate 5 onto the wind-up roll 20a. Thus, in the baking chamber 40a, the plurality of guide rolls 11a through 18a are arranged clockwise in a spiral pattern in the order that the film substrate 5 is passed over the guide rolls 11a through 18a.

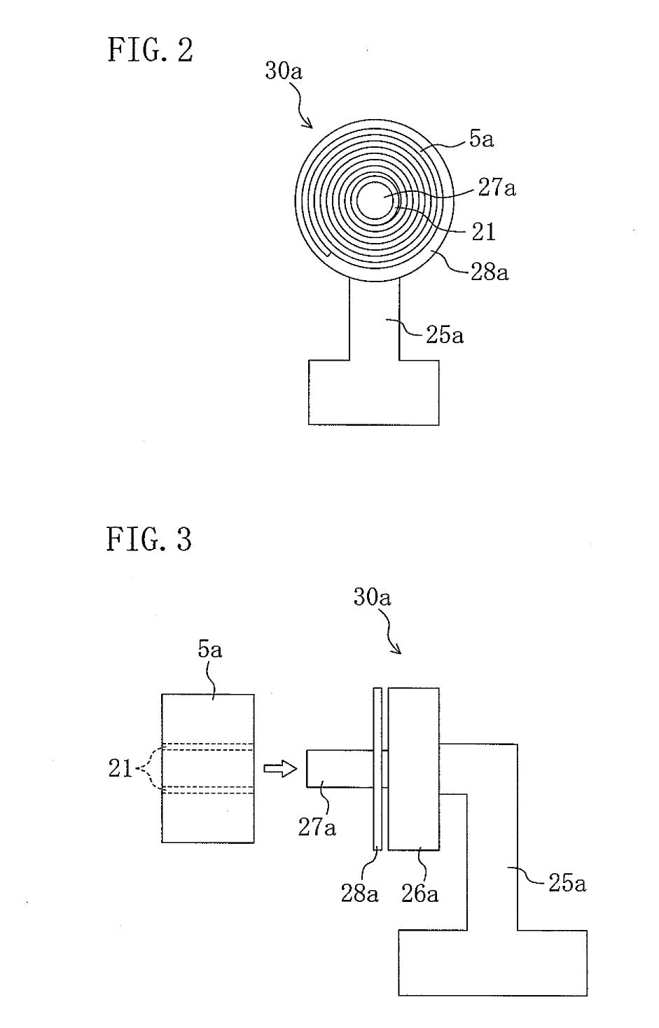

Moreover, a film substrate 5a wound up in a roll form on the wind-up roll 20a is carried out of the baking chamber 40a by a transferring apparatus 30a shown in FIGS. 2 and 3. Note that FIG. 2 is a front view of the transferring apparatus 30a of the baking apparatus 50a, and FIG. 3 is a side view thereof.

As shown in FIGS. 2 and 3, the transferring apparatus 30a includes a base portion 25a provided so as to be movable on the floor surface F of the baking chamber 40a, a roll receiving portion 26a provided on the upper portion of the base portion 25a, a round-bar-shaped insertion portion 27a provided in the roll receiving portion 26a so as to protrude therefrom, and a push-out ring 28a provided on the peripheral wall of the insertion portion 27a so that the inner peripheral wall of the push-out ring 28a is slidable thereon. When removing the film substrate 5a wound up in a roll form on the wind-up roll 20a, the insertion portion 27a is inserted into a hollow portion in the core 21 of the film substrate 5a in a roll form, thereby supporting the film substrate 5a in a roll form together with the core 21. Moreover, when removing the film substrate 5a in a roll form from the transferring apparatus 30a, the push-out ring 28a is moved away from the roll receiving portion 26a, thereby pushing out the film substrate 5a in a roll form together with the core 21.

Next, the film substrate 5, which is continuously processed by the baking apparatus 50a of the above structure, will be described.

The film substrate 5 is a TFT (thin film transistor) mother substrate or a color filter mother substrate, which is fabricated by using a plastic film, such as a polyimide film having, for example, a width of about 500 mm, a length of about 50 m, and a thickness of about 100 μm, and in which a plurality of display regions are defined in a matrix pattern along the longitudinal direction and the width direction.

Each display region of the TFT mother substrate includes, for example, a plurality of gate lines provided so as to extend parallel to each other, a plurality of source lines provided so as to extend parallel to each other in a direction perpendicular to the gate lines, a plurality of TFTs respectively provided at the intersections of the gate lines and the source lines, and a plurality of pixel electrodes provided respectively corresponding to the TFTs, and has a structure of a so-called active matrix substrate.

Each display region of the color filter mother substrate includes, for example, a black matrix provided in a grid pattern, colored layers of R, G, and B provided between black matrix grid lines, and a common electrode arranged so as to cover the black matrix and the colored layers, and has a structure of a so-called counter substrate.

A method for baking the alignment film 6 on the film substrate 5 by using the baking apparatus 50a of the above structure will be described below.

First, for example, a polyimide solution is applied to the surface of the film substrate 5 by using a roll-to-roll flexographic printing apparatus, and then, the substrate is heated to about 110° C., for example, to evaporate a solvent in the applied film, whereby the alignment film 6 is printed.

Then, as shown in FIG. 1, the film substrate 5, having the alignment film 6 printed thereon, is passed to the feed roll 10a, and is then sequentially passed to the guide rolls 11a through 18a in the baking chamber 40a preheated to about 200° C. Then, the film substrate 5 is wound up onto the wind-up roll 20a through the core 21. The alignment film 6 on the film substrate 5 is baked in this manner. At this time, if it is necessary to prevent contact between the surfaces of the film substrate 5 wound up on the wind-up roll 20a, a narrow releasing film or the like, for example, may be inserted in both side ends of the film substrate 5.

Moreover, after the transferring apparatus 30a is moved in the baking chamber 40a so that the tip of the insertion portion 27a is brought into contact with one end of the rotation shaft S of the wind-up roll 20a, the film substrate 5a in a roll form on the wind-up roll 20a is slid together with the core 21 onto the insertion portion 27a, whereby the film substrate 5a in a roll form is attached to the transferring apparatus 30a in the state where the film substrate 5a is supported by the insertion portion 27a. Then, the transferring apparatus 30a, having the film substrate 5a in a roll form attached thereto, is moved out of the baking chamber 40a to carry the film substrate 5a in a roll form out of the baking chamber 40a. Then, the film substrate 5a in a roll form is moved into a cooling chamber (not shown) and cooled.

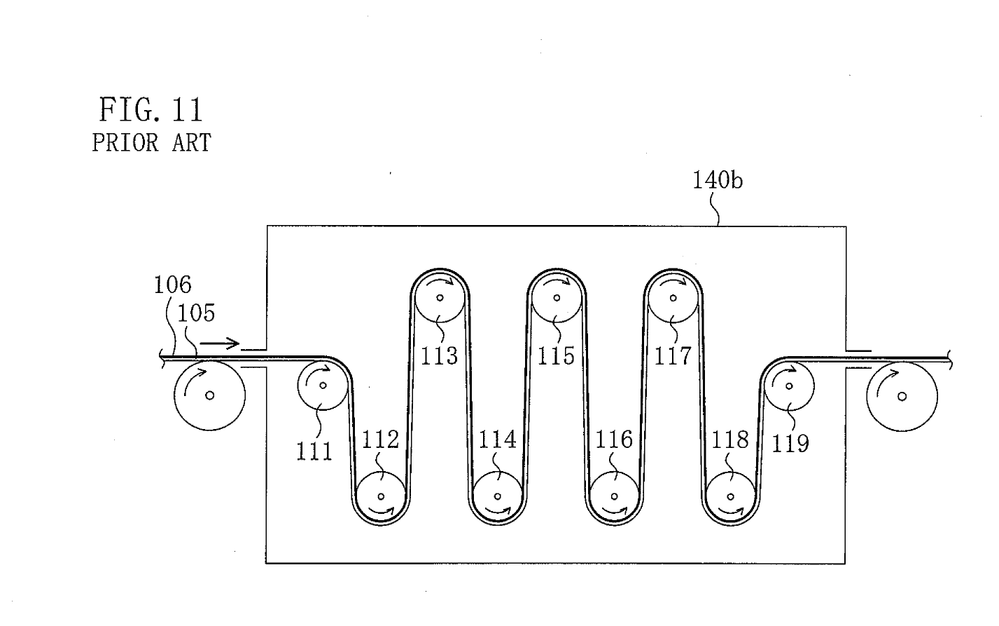

As described above, according to the baking apparatus 50a of the present preferred embodiment, even if the respective diameters of the guide rolls 11a through 18a are increased in order to prevent damage to the film substrate 5, the guide rolls 11a through 18a, to which the film substrate 5 is sequentially passed, are arranged in a spiral pattern in the baking chamber 40a in the order that the film substrate 5 is passed over the guide rolls 11a through 18a, and thus, the footprint of the baking chamber 40a can be reduced as compared to, for example, the case where the plurality of guide rolls 111 through 119 are arranged alternately in the upper and lower positions (see FIG. 11). Thus, the alignment film 6 on the film substrate 5 can be baked, while reducing the footprint, and damage to the substrate as much as possible.

Moreover, according to the baking apparatus 50a of the present preferred embodiment, since the respective rotation shafts S of the guide rolls 11a through 18a extend in the horizontal direction, the film substrate 5 is transferred along the guide rolls 11a through 18a so that the film substrate 5 is held horizontally in its width direction. Thus, even if the temperature in the baking chamber 40a varies along the height direction, the film substrate 5 can be heated uniformly in the width direction.

### Second Preferred Embodiment

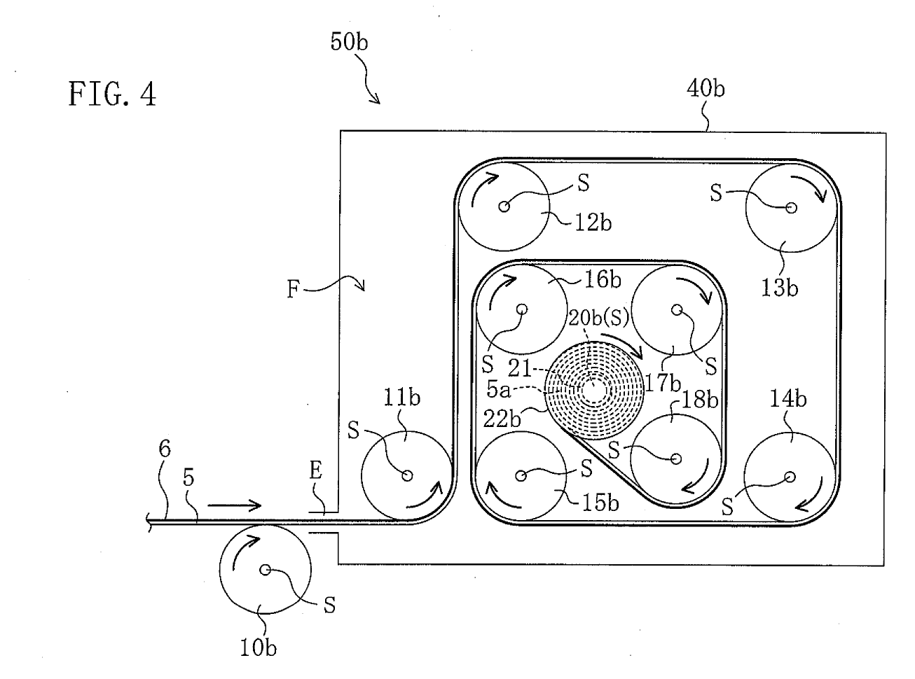

FIGS. 4 through 6 show a second preferred embodiment of the baking apparatus of the present invention. Note that, in the following preferred embodiments, the same elements as those of FIGS. 1 through 3 are denoted with the same characters, and detailed description thereof will be omitted.

FIG. 4 is a top view specifically showing the internal structure of a baking apparatus 50b of the present preferred embodiment.

As shown in FIG. 4, like the baking apparatus 50a of the first preferred embodiment, the baking apparatus 50b includes, for example, a feed roll 10b for feeding a film substrate 5, having an alignment film 6 printed thereon by an alignment-film printing apparatus (not shown) in the previous step, to the next step, and a baking chamber 40b for baking the alignment film 6 on the film substrate 5 which has been carried into the baking chamber 40b through a carry-in port E after being fed by the feed roll 10b.

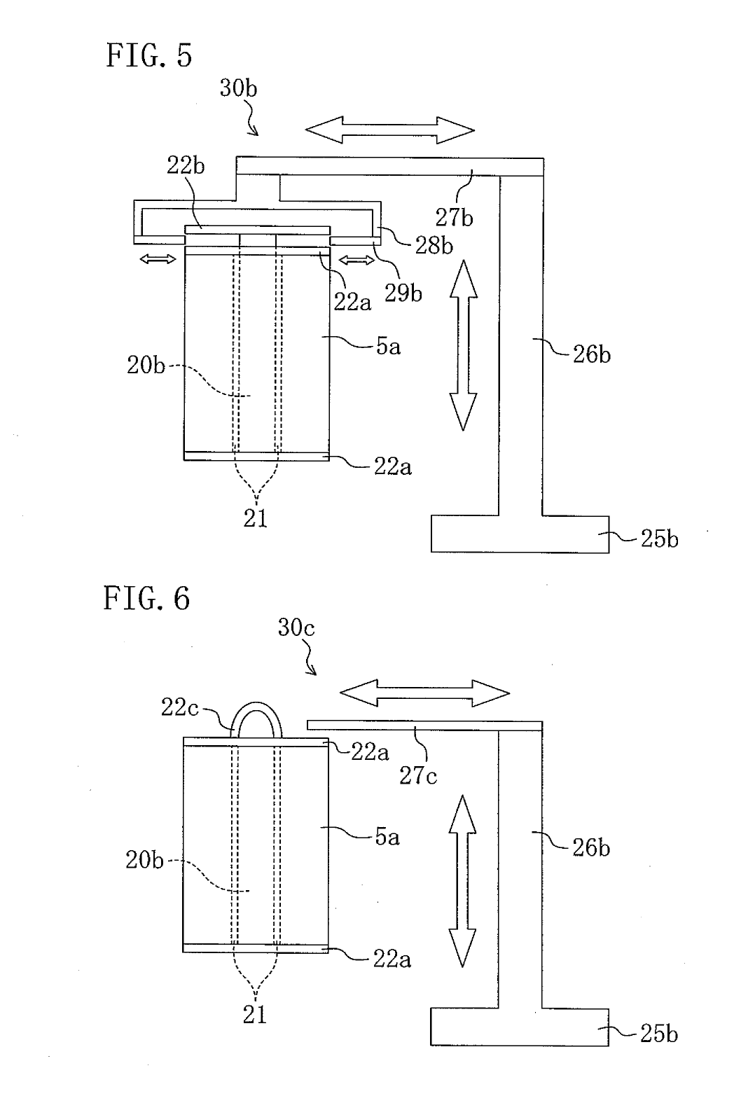

As shown in FIG. 4, the baking chamber 40b includes the following components inside: a plurality of guide rolls 11b through 18b; a wind-up roll 20b for winding up the film substrate 5 from the eighth guide roll 18b; and a heater (not shown) for heating the inside of the baking chamber 40b. The structure of the guide rolls 11b through 18b is similar to that of the guide rolls 11a through 18a of the first preferred embodiment, respectively, except that the respective rotation shafts S of the guide rolls 11b through 18b extend in a direction perpendicular or substantially perpendicular to a floor surface F of the baking chamber 40b, that is, in the vertical direction. Moreover, a rotation shaft S of the wind-up roll 20b extends in a direction perpendicular or substantially perpendicular to the floor surface F of the baking chamber 40b, that is, in the vertical direction. The wind-up roll 20b includes a pair of disc-shaped substrate receiving portions 22a provided on both side ends of the wind-up roll 20b, and a disc-shaped latch portion 22b provided spaced apart from the upper substrate receiving portion 22a (see FIG. 5).

The heater preferably is an infrared heater, a hot air circulating heater, or the like.

Moreover, a film substrate 5a, wound up in a roll form on the wind-up roll 20b, is carried out of the baking chamber 40b by a transferring apparatus 30b shown in FIG. 5. Note that FIG. 5 is a side view of the transferring apparatus 30b of the baking apparatus 50b. FIG. 6 is a side view of a transferring apparatus 30c having another structure, corresponding to the transferring apparatus 30b.

As shown in FIG. 5, the transferring apparatus 30b includes a base portion 25b provided so as to be movable on the floor surface F of the baking chamber 40b, a support portion 26b provided so as to stand on the base portion 25b in a vertically retractable manner, an arm portion 27b provided on top of the support portion 26b in a horizontally retractable manner, and an engaging portion 28b provided at the tip of the arm portion 27b, for engaging and holding the wind-up roll 20b. The engaging portion 28b includes a pair of insertion pins 29b provided at the tip of the engaging portion 28b in a horizontally retractable manner. When carrying the film substrate 5a in a roll form out of the baking chamber 40b, the insertion pins 29b are inserted between the upper substrate receiving portion 22a and the latch portion 22b which are provided in the upper portion of the wind-up roll 20b, and the support portion 26b and the arm portion 27b are extended and retracted in this state so as to lift the film substrate 5a in a roll form together with the wind-up roll 20b, the core 21, the substrate receiving portions 22a, and the latch portion 22b.

Moreover, as shown in FIG. 6, the transferring apparatus 30c includes a base portion 25b provided so as to be movable on the floor surface F of the baking chamber 40b, a support portion 26b provided so as to stand on the base portion 25b in a vertically retractable manner, and an engaging arm portion 27c provided on top of the support portion 26b in a horizontally retractable manner, for engaging and holding the wind-up roll 20b. As shown in FIG. 6, the wind-up roll 20b herein includes an inverted U-shaped latch portion 22c on the upper surface of the upper substrate receiving portion 22a. When carrying the film substrate 5a in a roll form out of the baking chamber 40b, the engaging arm portion 27c is inserted into a hole of the latch portion 22c provided in the upper portion of the wind-up roll 20b, and the support portion 26b and the engaging arm portion 27c are extended and retracted in this state so as to lift the film substrate 5a in a roll form together with the wind-up roll 20b, the core 21, the substrate receiving portions 22a, and the latch portion 22c.

A method for baking an alignment film by using the baking apparatus 50b of the above structure is different from that of the first preferred embodiment only in that the film substrate 5 is transferred so that the film substrate 5 is held vertically in its width direction, instead of being transferred so that the film substrate 5 is held horizontally in its width direction as in the first preferred embodiment. Thus, detailed description of the method will be omitted.

As described above, according to the baking apparatus 50b of the present preferred embodiment, the alignment film 6 on the film substrate 5 can be baked, while reducing the footprint and damage to the substrate as much as possible, even in the case where the respective rotation shafts S of the guide rolls 11b through 18b extend in the vertical direction.

Moreover, according to the baking apparatus 50b of the present preferred embodiment, since the respective rotation shafts S of the guide rolls 11b through 18b extend in the vertical direction, the film substrate 5 is transferred along the guide rolls 11b through 18b so that the film substrate 5 is held vertically in its width direction. Thus, for example, in the case where the inside of the baking chamber 40b is heated by an infrared heater, and there is a large temperature variation along the height direction in the baking chamber 40b, the film substrate 5 can be heated under different conditions on both sides of the film substrate 5 along its width direction. Note that, in the case of heating the film substrate 5 uniformly in the width direction, the inside of the baking chamber 40b can be heated by, for example, a hot air circulating heater to reduce a temperature variation along the height direction in the baking chamber 40b.

### Third Preferred Embodiment

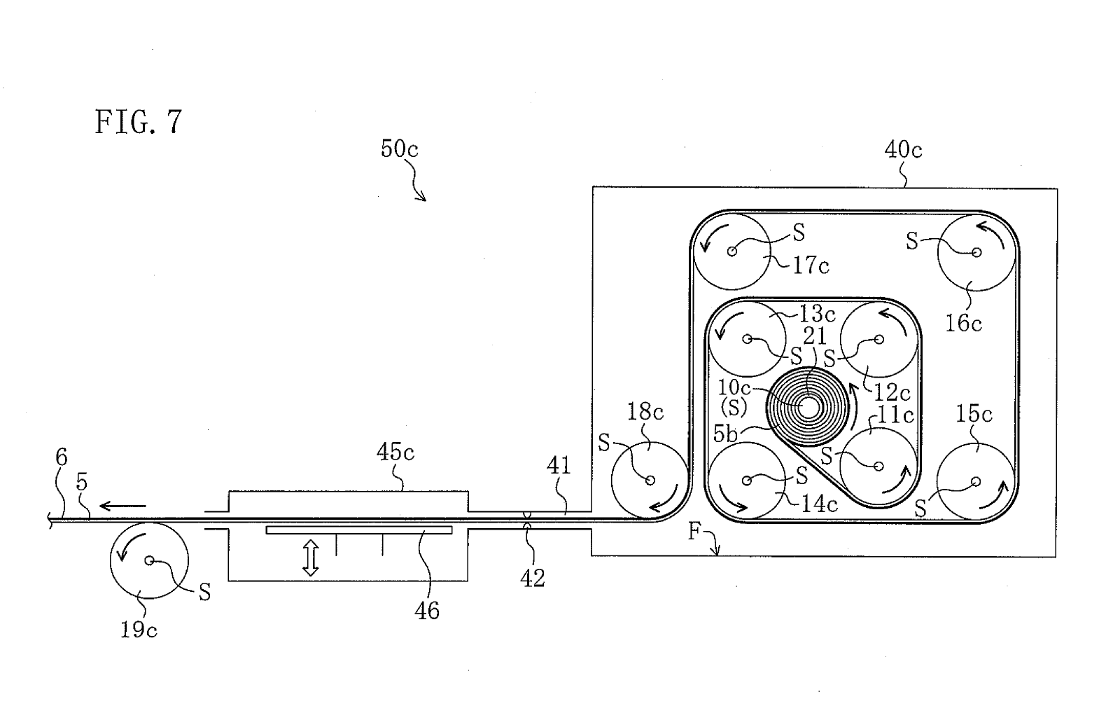

FIG. 7 is a side view specifically showing the internal structure of a baking apparatus 50c of the present preferred embodiment.

As shown in FIG. 7, the baking apparatus 50c includes a baking chamber 40c for baking an alignment film 6 on a film substrate 5, a cooling chamber 45c connected to the baking chamber 40c through a connection portion 41, for cooling the film substrate 5 fed from the baking chamber 40c, and a feed roll 19c for feeding the film substrate 5, fed from the cooling chamber 45c, to the next step.

As shown in FIG. 7, the baking chamber 40c includes the following components inside: a wind-off roll 10c provided in the central portion in the figure, for winding off the film substrate 5; a first guide roll 11c provided on the lower right side of the wind-off roll 10c in the figure, for guiding the film substrate 5 from the wind-off roll 10c in the lower right direction in the figure; a second guide roll 12c provided above the first guide roll 11c in the figure, for guiding the film substrate 5 from the first guide roll 11c in the upward direction in the figure; a third guide roll 13c provided on the left side of the second guide roll 12c in the figure, for guiding the film substrate 5 from the second guide roll 12c in the left direction in the figure; a fourth guide roll 14c provided below the third guide roll 13c in the figure, for guiding the film substrate 5 from the third guide roll 13c in the downward direction in the figure; a fifth guide roll 15c provided in the lower right portion in the figure, for guiding the film substrate 5 from the fourth guide roll 14c in the right direction in the figure; a sixth guide roll 16c provided in the upper right portion in the figure, for guiding the film substrate 5 from the fifth guide roll 15c in the upward direction in the figure; a seventh guide roll 17c provided in the upper left portion in the figure, for guiding the film substrate 5 from the sixth guide roll 16c in the left direction in the figure; an eighth guide roll 18c provided in the lower left portion in the figure, for guiding the film substrate 5 from the seventh guide roll 17c in the downward direction in the figure, and then, guiding the film substrate 5 in the left direction in the figure to feed the film substrate 5 to the connection portion 41; and a heater (not shown) for heating the inside of the chamber.

Respective rotation shafts S of the wind-off roll 10c and the guide rolls 11c through 18c extend in a direction parallel or substantially parallel to a floor surface F of the baking chamber 40c, that is, in the horizontal direction.

The heater preferably is an infrared heater, a hot air circulating heater, or the like.

As shown in FIG. 7, the baking chamber 40c is configured to bake the alignment film 6 on the film substrate 5, while sequentially passing the film substrate 5, wound off from the wind-off roll 10c, to the guide rolls 11c through 18c, and then, to feed the film substrate 5 to the cooling chamber 45c. Thus, in the baking chamber 40c, the plurality of guide rolls 11c through 18c are arranged counterclockwise in a spiral pattern in the order that the film substrate 5 is passed.

The cooling chamber 45c includes a cooling plate 46 for cooling the film substrate 5 by contacting the lower surface of the film substrate 5. The cooling plate 46 is herein configured so that a refrigerant, such as cooling water, circulates within the cooling plate 46, and also, is provided so as to be movable up and down within the cooling chamber 45c.

The connection portion 41 includes a pair of thermally insulating valves 42 which are preferably made of silicone rubber or other suitable material, for respectively contacting the upper and lower surfaces of the film substrate 5 to prevent heat inside the baking chamber 40c from entering the cooling chamber 45c.

A method for baking the alignment film 6 on the film substrate 5 by using the baking apparatus 50c of the above structure will be described below.

First, for example, a polyimide solution is applied to the surface of the film substrate 5 by using a roll-to-roll flexographic printing apparatus, and then, the substrate is heated to about 110° C., for example, to evaporate a solvent in the applied film, whereby the alignment film 6 is printed. Then, the film substrate 5, having the alignment film 6 printed thereon, is wound up in a roll form onto a core 21, while, for example, inserting a narrow releasing film or the like in both side ends of the film substrate 5.

Then, a film substrate 5b wound up in a roll form is attached together with the core 21 to the insertion portion 27a of the transferring apparatus 30a of the first preferred embodiment. The transferring apparatus 30a is moved in the baking chamber 40c preheated to about 200° C., for example, so that the tip of the insertion portion 27a is brought into contact with one end of the rotation shaft S of the wind-off roll 10c. Then, the film substrate 5b in a roll form, located on the insertion portion 27a, is slid together with the core 21 onto the wind-off roll 10c, whereby the film substrate 5b in a roll form is attached to the wind-off roll 10c.

Moreover, the film substrate 5 is wound off from the film substrate 5b in a roll form attached to the wind-off roll 10c, and then, as shown in FIG. 7, is sequentially passed to the guide rolls 11c through 18c, thereby baking the alignment film 6 on the film substrate 5.

Thereafter, the film substrate 5, which has the alignment film 6 baked, and has been transferred to the cooling chamber 45c through the connection portion 41, is cooled by bringing the cooling plate 46 into contact with the lower surface of the film substrate 5. Then, the cooled film substrate 5 is fed to the next step via the feed roll 19c.

As described above, according to the baking apparatus 50c of the present preferred embodiment, even if the respective diameters of the guide rolls 11c through 18c are increased in order to prevent damage to the film substrate 5, the guide rolls 11c through 18c, to which the film substrate 5 is sequentially passed, are arranged in a spiral pattern in the baking chamber 40c in the order that the film substrate 5 is passed over the guide rolls 11c through 18c, and thus, the footprint of the baking chamber 40c can be reduced as compared to, for example, the case where the plurality of guide rolls 111 through 119 are arranged alternately in the upper and lower positions (see FIG. 11). Thus, the alignment film 6 on the film substrate 5 can be baked, while reducing the footprint and damage to the substrate as much as possible.

Moreover, according to the baking apparatus 50c of the present preferred embodiment, since the respective rotation shafts S of the guide rolls 11c through 18c extend in the horizontal direction, the film substrate 5 is transferred along the guide rolls 11c through 18c so that the film substrate 5 is held horizontally in its width direction. Thus, even if the temperature in the baking chamber 40c varies along the height direction, the film substrate 5 can be heated uniformly in the width direction.

### Fourth Preferred Embodiment

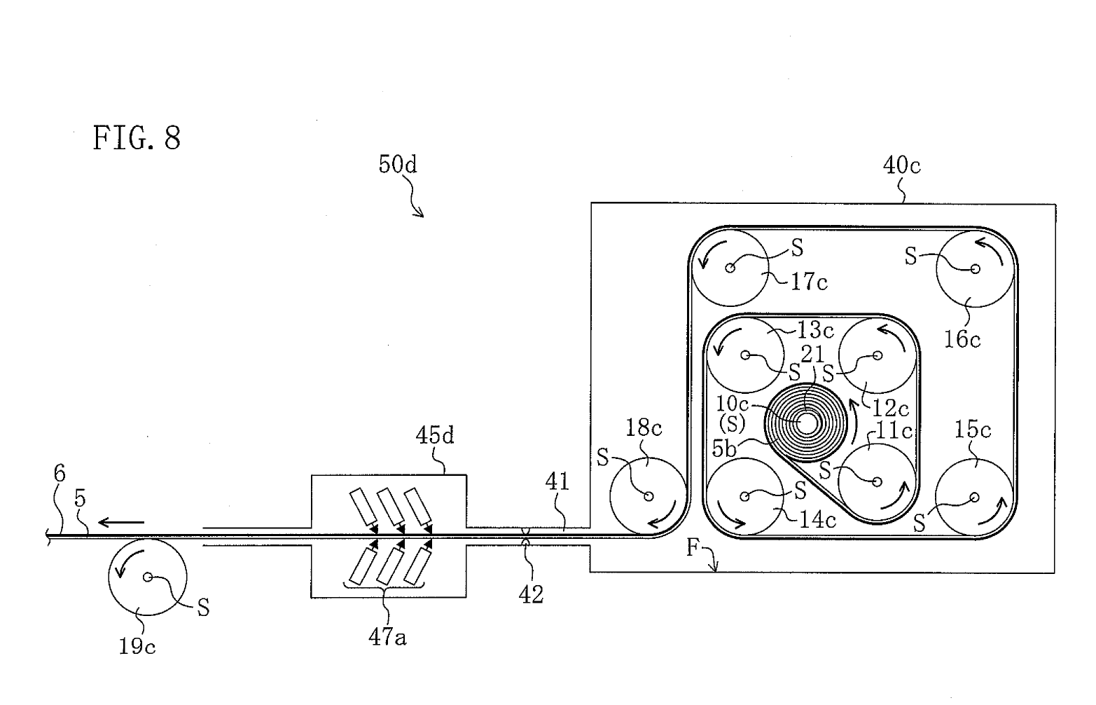

FIG. 8 is a side view specifically showing the internal structure of a baking apparatus 50d of the present preferred embodiment.

As shown in FIG. 8, the baking apparatus 50d includes the baking chamber 40c of the third preferred embodiment, a cooling chamber 45d connected to the baking chamber 40c through a connection portion 41, for cooling a film substrate 5 fed from the baking chamber 40c, and a feed roll 19c for feeding the film substrate 5, fed from the cooling chamber 45d, to the next step.

The cooling chamber 45d includes a plurality of jet nozzles 47a for blowing air to the upper and lower surfaces of the film substrate 5 to cool the film substrate 5.

A method for baking an alignment film by using the baking apparatus 50d of the above structure is different from that of the third preferred embodiment only in that the film substrate 5 is cooled by blowing air to the film substrate 5, instead of being cooled by bringing the film substrate 5 into contact with the cooling plate 46 as in the third preferred embodiment. Thus, detailed description of the method will be omitted.

According to the baking apparatus 50d of the present preferred embodiment, the alignment film 6 on the film substrate 5 can be baked, while reducing the footprint, and damage to the substrate as much as possible, as in the case of the baking apparatus 50c of the third preferred embodiment.

### Fifth Preferred Embodiment

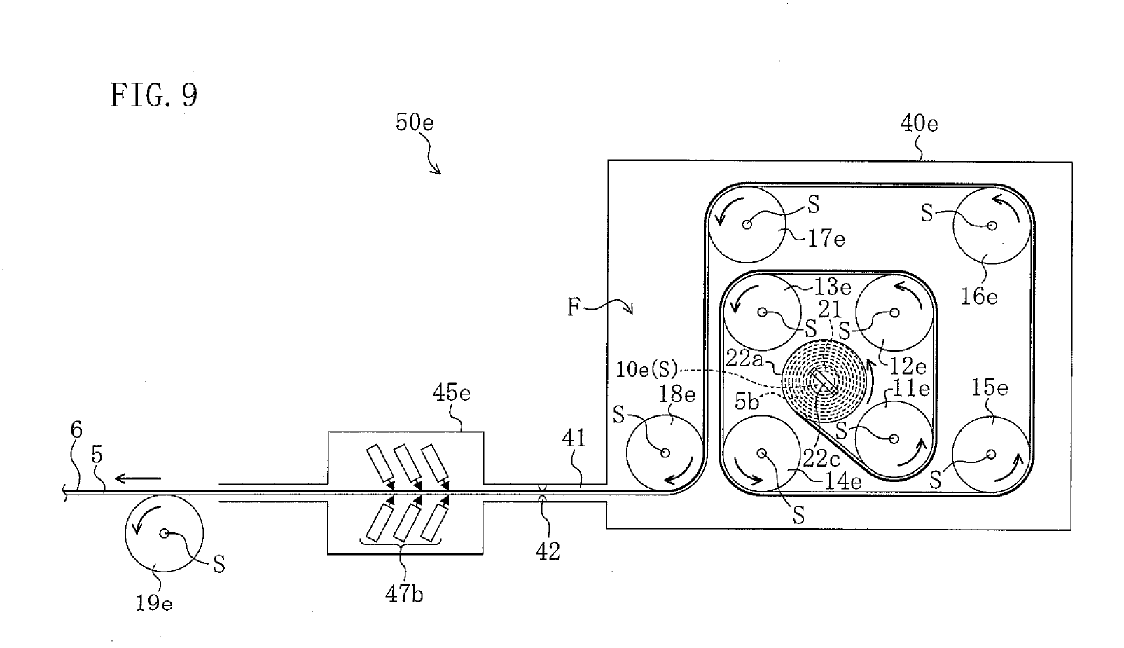

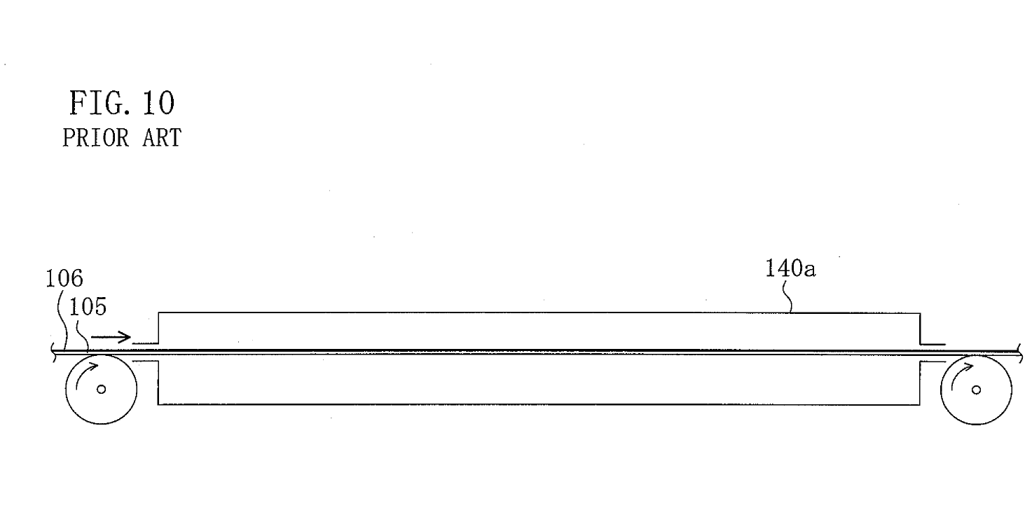

FIG. 9 is a top view specifically showing the internal structure of a baking apparatus 50e of the present preferred embodiment.

As shown in FIG. 9, the baking apparatus 50e includes a baking chamber 40e for baking an alignment film 6 on a film substrate 5, a cooling chamber 45e connected to the baking chamber 40e through a connection portion 41, for cooling the film substrate 5 fed from the baking chamber 40e, and a feed roll 19e for feeding the film substrate 5, fed from the cooling chamber 45e, to the next step.

As shown in FIG. 9, the baking chamber 40e includes the following components inside: a wind-off roll 10e provided in the central portion in the figure, for winding off the film substrate 5; a first guide roll 11e provided on the lower right side of the wind-off roll 10e in the figure, for guiding the film substrate 5 from the wind-off roll 10e in the lower right direction in the figure; a second guide roll 12e provided above the first guide roll 11e in the figure, for guiding the film substrate 5 from the first guide roll 11e in the upward direction in the figure; a third guide roll 13e provided on the left side of the second guide roll 12e in the figure, for guiding the film substrate 5 from the second guide roll 12e in the left direction in the figure; a fourth guide roll 14e provided below the third guide roll 13e in the figure, for guiding the film substrate 5 from the third guide roll 13e in the downward direction in the figure; a fifth guide roll 15e provided in the lower right portion in the figure, for guiding the film substrate 5 from the fourth guide roll 14e in the right direction in the figure; a sixth guide roll 16e provided in the upper right portion in the figure, for guiding the film substrate 5 from the fifth guide roll 15e in the upward direction in the figure; a seventh guide roll 17e provided in the upper left portion in the figure, for guiding the film substrate 5 from the sixth guide roll 16e in the left direction in the figure; an eighth guide roll 18e provided in the lower left portion in the figure, for guiding the film substrate 5 from the seventh guide roll 17e in the downward direction in the figure, and then, guiding the film substrate 5 in the left direction in the figure to feed the film substrate 5 to the connection portion 41; and a heater (not shown) for heating the inside of the chamber.

Respective rotation shafts S of the wind-off roll 10e and the guide rolls 11e through 18e extend in a direction perpendicular or substantially perpendicular to a floor surface F of the baking chamber 40e, that is, in the vertical direction.

The heater preferably is an infrared heater, a hot air circulating heater, or the like.

As shown in FIG. 9, the baking chamber 40e is configured to bake the alignment film 6 on the film substrate 5, while sequentially passing the film substrate 5, wound off from the wind-off roll 10e, to the guide rolls 11e through 18e, and then, to feed the film substrate 5 to the cooling chamber 45e. Thus, in the baking chamber 40e, the plurality of guide rolls 11e through 18e are arranged counterclockwise in a spiral pattern in the order that the film substrate 5 is passed over the guide rolls 11e through 18e.

The cooling chamber 45e includes a plurality of jet nozzles 47b for blowing air to the upper and lower surfaces of the film substrate 5 to cool the film substrate 5.

Note that, in FIG. 9, the wind-off roll 10e has a latch portion 22c on the upper surface of a substrate receiving portion 22a so that the wind-off roll 10e is transferred by the transferring apparatus 30c shown in FIG. 6.

A method for baking an alignment film by using the baking apparatus 50e of the above structure is different from that of the fourth preferred embodiment only in that the film substrate 5 is transferred so that the film substrate 5 is held vertically in its width direction, instead of being transferred so that the film substrate 5 is held horizontally in its width direction as in the fourth preferred embodiment. Thus, detailed description of the method will be omitted.

According to the baking apparatus 50e of the present preferred embodiment, the alignment film 6 on the film substrate 5 can be baked, while reducing the footprint, and damage to the substrate as much as possible, even in the case where the respective rotation shafts S of the guide rolls 11e through 18e extend in the vertical direction.

Moreover, according to the baking apparatus 50e of the present preferred embodiment, since the respective rotation shafts S of the guide rolls 11e through 18e extend in the vertical direction, the film substrate 5 is transferred along the guide rolls 11e through 18e so that the film substrate 5 is held vertically in its width direction. Thus, for example, in the case where the inside of the baking chamber 40e is heated by an infrared heater, and there is a large temperature variation along the height direction in the baking chamber 40e, the film substrate 5 can be heated under different conditions on both sides of the film substrate 5 along its width direction. Note that, in the case of heating the film substrate 5 uniformly in the width direction, the inside of the baking chamber 40e can be heated by, for example, a hot air circulating heater to reduce a temperature variation along the height direction in the baking chamber 40e.

The above preferred embodiments were described with respect to a baking apparatus for baking an alignment film on a substrate surface, as preferred embodiments of the present invention. However, the present invention is applicable also to a baking apparatus for baking (prebaking or post-baking) a resist for use in manufacturing of flexible displays such as liquid crystal displays and organic EL displays.

As described above, the present invention is capable of baking a thin film on a film substrate without damaging the film substrate, and thus, is useful for manufacturing flexible display panels.

While preferred embodiments of the present invention have been described above, it is to be understood that variations and modifications will be apparent to those skilled in the art without departing the scope and spirit of the present invention. The scope of the present invention, therefore, is to be determined solely by the following claims.

1-10. (canceled)

11: A baking apparatus, comprising:
a baking chamber; and
a plurality of guide rolls provided inside the baking chamber so that their respective rotation shafts extend parallel or substantially parallel to each other; wherein
the baking apparatus is configured and operative to bake a thin film on a film substrate contained in the baking chamber, while sequentially passing the film substrate to the plurality of guide rolls; and
the plurality of guide rolls are arranged in a spiral manner in an order that the film substrate is passed over the plurality of guide rolls.

12: The baking apparatus of claim 11, wherein the respective rotation shafts of the guide rolls extend in a direction parallel or substantially parallel to a floor surface.

13: The baking apparatus of claim 11, wherein the respective rotation shafts of the guide rolls extend in a direction perpendicular or substantially perpendicular to a floor surface.

14: The baking apparatus of claim 11, further comprising at least one of a wind-up roll arranged in a central portion of the baking chamber to wind up the film substrate which has been passed to the plurality of guide rolls, and a wind-off roll arranged in the central portion of the baking chamber to wind off the film substrate which is to be passed to the plurality of guide rolls.

15: The baking apparatus of claim 14, further comprising a transferring apparatus arranged to transfer the wind-up roll or the wind-off roll.

16: The baking apparatus of claim 15, wherein a rotation shaft of the wind-up roll or the wind-off roll extends parallel or substantially parallel to a floor surface, and the transferring apparatus is configured to support the rotation shaft of the wind-up roll or the wind-off roll.

17: The baking apparatus of claim 15, wherein a rotation shaft of the wind-up roll or the wind-off roll extends perpendicularly or substantially perpendicularly to a floor surface, and the transferring apparatus is configured to latch an upper portion of the wind-up roll or the wind-off roll.

18: The baking apparatus of claim 11, further comprising a wind-off roll arranged in a central portion of the baking chamber so as to wind off the film substrate which is to be passed to the plurality of guide rolls, and a cooling chamber arranged outside of the baking chamber to cool the film substrate which has been passed to the plurality of guide rolls after being wound off from the wind-off roll.

19: The baking apparatus of claim 18, further comprising a cooling plate arranged in the cooling chamber to cool the film substrate by contacting the film substrate.

20: The baking apparatus of claim 18, further comprising a jet nozzle arranged in the cooling chamber to blow air to the film substrate to cool the film substrate.
